(19) United States
(12) Patent Application Publication
(10) Pub. No.: US 2006/0107055 A1
(43) Pub. Date: May 18, 2006

(54) Method and system to detect a data pattern of a packet in a communications network

(75) Inventors: Ramesh Kumar Panwar, Pleasanton, CA (US); Joseph John Tardo, Palo Alto, CA (US); Manish Mandhar Kadam, Pune (IN); Swati Sanjeev Deshpande, Pune (IN); Sunil Aurora, Gurgaon (IN)

Correspondence Address: Patrick Reilly, Box 7218, Santa Cruz, CA, 95061-7218, US

(73) Assignee: Nesvis, Networks, Santa Clara, CA (US)

(21) Appl. No.: 10/990,945

(22) Filed: Nov. 17, 2004

(51) Int. Cl. H04L 9/00

(52) U.S. Cl. 713/176

(57) ABSTRACT

A method and system for detecting a pattern derived from or related to a data signature in data packets is provided. An intrusion detection module accepts a data packet and compares all or portions of the data packet with a set of data patterns. One or more data patterns may be related to, or indicate the existence of, or derived from a virus or other data structure, software code, software program, portions of content of a data packet, a universal resource locater, and/or a traffic classification indicator.

### FIELD OF THE INVENTION

The present invention relates to the detection of a data pattern by a computational system. The present invention more particularly relates to the rapid detection of a data pattern matching a signature, wherein the data pattern may be located within a formatted message or other data file.

### BACKGROUND OF THE INVENTION

Organizations, such as government departments and business enterprises that are dependent upon information technology systems often seek to detect the presence of a one or more specific data patterns within incoming messages, outgoing messages, data files or other accessible patterns.

This need to sift through volumes of data to detect the presence of particular data patterns, is felt by numerous businesses, agencies and other organizations that possess proprietary communications networks that are communicatively coupled with the Internet or other external communications networks, such as a telephony network. This communicative engagement of these in-house communication networks typically enable the served organization to more effectively transmit and receive critical information and messages in rapid and accessible methodologies. In fact, many organizations could not function at an acceptable performance level without information technology communication from their internal network(s) to the Internet or other external communications system. However access to the proprietary network by incoming messages and computer-readable media bearing software code sourced from outside of the network creates a potential for the network to accept particular pre-identified data patterns without detection by a system administrator.

Network computers are often tasked as simultaneously providing a bridge and a gate between a private network and an external network. In their bridging function, network computers enable transmission of data traffic, to include electronic messages, to and from a distinct network. In their gating function, network computers may be directed to examine data traffic and, under pre-established conditions, to impede or deny transmission of data traffic. As described below, network computers may be employed under the International Standards Organization (ISO) Open Source Interconnection (OSI) network model to provide the most fundamental layers of connectivity between the private network and external information technology systems. As network computers may also be positioned within a private network to manage and enable communication among computational elements of the network, a set of network computers of a communications network can be positioned to monitor the nature of data traffic to and from, as well as within, a communications network.

Yet permitting electronic messages to pass from an external entity into a proprietary or private communications network (“network”) often creates the possibility of a security breach of the network by a computer software security exploit, such as a worm. It is well understood that a computer software virus is software that is executed by a computer without the knowledge or authorization of the computer user. The term virus as defined herein includes all forms of undesirable progam or executable content, including spyware, worms, adware, and other software that penetrates a network or an element of the network, such as a computer, wherein this penetration is not desired by a computer user, network manager, or other party having an interest in the network, whether the intent of the exploit is malicious or not.

Upon activation, certain types of virus software will initiate an attack on the network by making unauthorized and unwanted modifications to one or more components of, or to information stored on, a computer or other element of the network. In particular, some computer viruses are capable of altering or destroying data stored on disk, scrambling characters or symbols on a monitor screen, displaying messages, and other damaging acts. Many viruses' attacks include attempts to propagate themselves (i.e., “amplify”) onto other elements of the network. This amplification may be directed in part to accessible computer-readable media, to include non-volatile memory such as portable memory devices, diskettes or hard disks.

To overcome the problems created by computer viruses, users have developed a variety of “anti-virus” programs that both detect and remove known viruses. Most anti-virus software programs search for certain characteristic behaviors of the known computer viruses. Once detected, the computer viruses are removed. Examples of commercially available anti-virus programs include Spy Sweeper™ by Webroot and AntiVirus by Symantec. The term “anti-virus software” is intended to include all such software, including those that inspect network traffic for malicious content and execute in a network computer as well as the aforementioned examples that execute on client and server end systems.

Viruses sometimes reside within a piece of executable code attached to a bona fide electronic message or computer software program. A network can be breached in many ways. A network can be penetrated by a properly authorized user installing a software program onto a computer from computer-readable media, whereby the virus can penetrate the network from a trusted element of the network, as well as by reception via a communications link from an external network. These user-introduced infections can be very difficult to detect and eradicate by prior art network computers, as the sheer volume of traffic to inspect can overwhelm many such systems.

Prior art anti-virus software employed to detect attempted or successful intrusions into a network can be effective but require significant application of computational resources of the network. These anti-virus programs usually receive updates of signatures of newly active or identified viruses from a trusted outside source. The producers of anti-virus software maintain secure records of such signatures which may be, for example, checksums.

Many networks use an Open Source Interconnection network model wherein a seven layer-networking framework implements specific protocols at each layer. Prior art anti-virus software is more demanding of network computational resources when it operates at the higher layers. The application layer is the highest level, or level seven. The application layer supports end-user processes and software application execution. In this level seven sources and targets of communications are identified, quality of service is recognized, user authentication and privacy are addressed, and data syntax constraints are taken into account. The operations at level seven are application-specific. The application layer supports Telnet and FTP applications and includes tiered application architectures.

The sixth layer, or presentation layer, translates from application to network format, and vice versa, to provides independence from encryption formats and other differences in data representation. The syntax layer provides freedom from data format incompatibility by formatting and encrypting data to be sent across the network, providing freedom from compatibility problems. Data is thereby transformed by the presentation layer, also known as the syntax layer, into a form that the application layer can implement.

A session layer addresses session and connection coordination between applications. This fifth layer establishes, coordinates, and terminates conversations, exchanges, and dialogues and other communications activities between two or more applications.

The transport layer effectuates transfer of data between elements of the network. This fourth layer provides end-to-end error recovery and is responsible for complete data transfer.

The third layer, or network layer, creates virtual for transmitting data from node to node by means of circuits switching and routing actions. The network layer executes packet addressing and sequencing, routing and forwarding, internetworking, error handling, and congestion management

At the second layer, or data link layer, data packets are encoded and decoded into bits. The data link layer handles errors in the physical layer, flow control and frame synchronization and provides transmission protocol knowledge and management to the network. A Media Access Control sublayer, or MAC sublayer, of the data link layer controls how computers and other elements of the network gain access to data and permission to transmit messages. An LLC sublayer controls frame synchronization, aspects of flow control, and error checking.

The physical layer conveys the bit streams into and out of the network, at the electrical and mechanical level. This first layer employs the hardware means of sending and receiving data on a carrier by delivering electrical impulses, light or radio signals to and from the network. The physical layer defines cables, cards, and other physical aspects of the network.

The higher the level within which an anti-virus functions generally the greater the demand on network resources imposed by the anti-virus software on the network. It is therefore a long felt need to generate systems and software that can efficiently and rapidly detect a specified data pattern in messages and data files entering, leaving, stored within, or accessible to an information technology system or network. As a subset of this long felt need, for pattern detection, there is a widely felt need to detect an attempted penetration, or presence, of a virus into or within a network and at lower levels of the networking protocol network.

### SUMMARY OF THE INVENTION

These and other objects will be apparent in light of the prior art and this disclosure. The present invention provides a method and system for detecting a pattern included within and or derived from a data packet received from, or an electronic document accessible via, a source located off-chip and communicated to a pattern detection module. It is understood that the pattern detection module may be configured in part or entirely on a single semiconductor substrate, wherein an element of the pattern detection module may be located on-chip with one or more other elements of the pattern detection module.

In a first preferred embodiment of the method of the present invention a computational system is provided for detection of a data pattern comprised within a data file, such as a packet of an electronic message or other electronic document. A pattern detection module, configured as intrusion detection module of the computational system, is informed of one or more patterns of data to seek in the data file. These sought for data patterns are referred to as signatures and are stored within or accessible to signature blocks of the intrusion detection module. It is understood that the presence of a data pattern that is coded in a signature my present a data pattern that is not a portion of a worm or virus, but may rather indicate an actual or potential activity or attempted intrusion by or of a virus or worm.

It is further understood that seeking the presence of signatures in the data file may occur, in certain alternate preferred embodiments of the method, after the data of the data file has been modified by suitable techniques known in the art to seek obfuscated or otherwise arranged or encrypted data patterns.

In a first preferred embodiment of the present invention a pattern detection module is configured as an intrusion detection module and is programmed and employed to detect intrusions and attempted intrusions of a computer software virus (“virus”) into a communications network of an information technology system. In certain various alternate preferred embodiments of the method of the present invention the pattern of the data packet sought is related to or derived from a universal resource locator (“URL”), a portion of content data, a traffic classification indicator, and/or other computer software screening techniques. The first preferred embodiment of the method of the present invention provides an intrusion detection system for detecting a virus by identifying it's signature or bit pattern in a data packet, where the system includes a data packet normalization pipeline (“pipeline”), a signature block, and a shift register, where the pipeline accepts a data packet and generates a normalized data packet by hardware processing of the data packet. The normalized data packet is then sequenced through the shift register, and succeeding windows of the normalized data packet are compared with one or more virus signatures stored in the signature block. The normalization pipeline may optionally comprise one or more hardware normalization modules to include, a backslash converter circuit, a “/../” detector, a “/././” compressor, a numeric compressor, and/or a “whitespace” remover.

Certain alternate preferred embodiments of the method of the present invention comprise a method for determining if a data packet evidences a virus signature where the method includes one or more of the following steps:
a. providing a hardware packet normalization pipeline, the pipeline for normalizing the data packet by hardware processing;
b. providing a virus signature block, the virus signature block having a plurality of virus signature memory registers;
c. loading at least one virus signature memory registers with a virus signature;
d. entering the data packet into the hardware packet normalization pipeline;
e. generating a normalized data packet by processing the data packet through the hardware packet normalization pipeline; and
f. comparing windows of the normalized data packet with at least one virus signature stored in the virus signature block as the normalized data packet is sequenced through a shift register, in order to discover if the normalized data packet includes a virus signature.

In certain still alternate preferred embodiments of the present invention, an information technology system has a CPU, a shift register for streaming through a plurality of packets of binary data, a first signature register and a second signature register, wherein a method of pattern detection is executed, the method comprising:
a. storing a first signature in the first signature register;
b. storing a second signature in the second signature register;
c. sequencing a portion of a first data packet through the shift register;
d. substantively simultaneously comparing the first signature and the second signature with the contents of the shift register after each advance of the packet of the data stream through the shift register; and
e. reporting when a match is determined to exist between the instantaneous values of the shift register and either the first signature or the second signature.

The first signature and/or second signature may be a pattern related or derived from a virus, a URL a traffic classification indicator, and/or a portion of content of a data packet. There may be one or more value positions of a signature that is a “do not care” value or a case insensitive value.

The CPU may optionally prevent the transmission of a data packet to an address specified by the data packet when a match is determined to exist between the instantaneous values of the shift register and either the first signature or the second signature.

Certain still alternate preferred embodiments of the present invention include one or more of the following steps:
appending a last portion of the previous packet to the current data packet;
sequencing the data packet through the shift register;
comparing a remainder of the previous packet with the contents of the shift register after each advance of the data packet through the shift register;
reporting when a match is determined to exist between the instantaneous values of the shift register and the first signature.

Certain yet alternate preferred embodiments of the present invention include one or more of the following steps:
storing a first portion of the first signature in the first signature register;
storing a second portion of first signature in the second register, whereby the second signature comprises the second portion of the first signature; and
comparing the first portion of the first signature and second portion of the first signature using the first signature register and the second signature register in sequence with the instantaneous values of the shift register. The information technology system may further include a third signature register, where the third signature register records the value of a second or third signature, whereby the information technology system may substantively simultaneously compare the first signature and the second or third signature with the contents of the shift register after each advance of the first packet of the data stream through the shift register. The CPU may additionally be informed when a match is determined to exist between the instantaneous values of the shift register and either the first signature or the third signature.

The information technology system may, in certain yet alternate preferred embodiments of the present invention, include:
a data stream source and an integrated circuit, the data stream source coupled with the integrated circuit, and the data stream source providing a plurality of packets of binary data to the integrated circuit; and
the integrated circuit including a substrate, a central processing unit (“CPU”), a shift register for receiving and sequencing through the plurality of packets of binary data, a first signature register and a second signature register, wherein the CPU, the shift register, the signature registers are communicatively coupled for comparison processing and are located within the substrate;

Certain other alternate preferred embodiments of the present invention include an integrated circuit comprising a normalization pipeline, the normalization pipeline located within the substrate and communicatively coupled with the data source and the shift register, and the normalization pipeline for accepting the data stream from the data source, deriving a normalized binary pattern from a first packet of the data stream, and for providing the normalized binary pattern to the shift register, whereby the comparisons with the first signature and the second signature are made with a normalized binary pattern. The integrated circuit may further comprise a plurality of signature registers located within the substrate and communicatively coupled with the shift register, and the plurality of signature registers, each register for accepting a portion of a plurality of portions of the first signature, wherein the plurality of portions of the first signature are sequentially stored in the plurality of signature registers, and the plurality of portions of the first signature is sequentially compared against the instantaneous values of the shift register, whereby a data packet of length equal to or less than the first signature is substantially simultaneously compared for a match with a first packet of the plurality of data packets. In still other preferred embodiments of the method of the present invention, a plurality of portions of the first signature is sequentially compared against the instantaneous values of the first packet and a second packet as sequenced through the shift register, whereby two data packets of summed length equal to or less than the first signature is substantially simultaneously compared for a match with a first signature.

Certain still alternate preferred embodiments of the present invention provide a computer-readable memory medium on which are stored a plurality of computer-executable instructions for performing aspects of the present invention as recited herein

The information technology system, having a central processing unit (“CPU”), a shift register for streaming through binary data, and a first signature register and a second signature registers, may execute a method of virus intrusion detection comprising:
storing a first virus signature in the first signature register;
storing a second virus signature in the second signature register;
sequencing a binary data stream through the shift register;
substantively simultaneously comparing the first virus signature and the second virus signature against the contents of the shift register after each advance of the data stream through the shift register; and
reporting to the CPU when a match is determined to exist between the instantaneous values of the shift register and either the first virus signature or the second virus signature register.

Certain yet other alternate preferred embodiments of the present invention comprise a programmable logic device, such as a programmable gate array, to perform one or more of the steps or aspects of the present invention as recited herein.

Certain still alternate preferred embodiments of the method of the present invention enable and apply the intrusion detection module to detect the presence of data patterns wherein the data pattern is not a component of a virus or a worm, but indicates that an intrusion attempt may be in progress. Certain other alternate preferred embodiments of the method of the present invention enable and apply the intrusion detection module to detect the presence of data patterns wherein the data pattern is not a component of a pre-specified pattern, but where the detection of the data pattern does indicate a potential instantiation, presence, or attempted intrusion of a pre-specified data pattern.

Various modifications may be made without departing from the invention. It is understood that the invention has been disclosed herein in connection with certain examples and embodiments. However, such changes, modifications or equivalents as can be used by those skilled in the art are intended to be included. Accordingly, the disclosure is to be construed as exemplary, rather than limiting, and such changes within the principles of the invention as are obvious to one skilled in the art are intended to be included within the scope of the claims.

### BRIEF DESCRIPTION OF THE DRAWINGS

These, and further features of the invention, may be better understood with reference to the accompanying specification and drawings depicting the preferred embodiment, in which:

FIG. 1 illustrates an information technology system communicatively coupled by a physical layer of a networking framework with the Internet;

FIG. 1A is an alternate depiction of the elements of the information technology system of FIG. 1.

FIG. 2 is a representation of a first preferred embodiment of the present invention, or first system, of the network of FIG. 1;

FIG. 3A is a schematic diagram of an intrusion detection module of the first system of FIGS. 1 and 2;

FIG. 3B is a schematic diagram of a normalization pipeline of the intrusion detection module of FIG. 3A;

FIG. 4 is a schematic diagram of an alternate preferred embodiment of the present invention wherein the alternate preferred embodiment includes a central processing unit (“CPU”) and a programmable logic device;

FIG. 5 presents the meanings of selected 10-bit character encodings of a normalized portion of packet data as generated by a hardware normalization pipeline of the first system of FIGS. 1 and 2;

FIG. 6 presents a layout of signature blocks of the first system of FIGS. 1 and 2;

FIG. 7 presents a first syntax of each individual virus signature as stored in signature blocks of the first system of FIGS. 1 and 2;

FIG. 8 presents alternate virus signature syntax of signatures as stored in the signature blocks of FIGS. 1 and 2;

FIG. 9 presents a state payload resulting from a comparison of the processed or normalized packet data with the virus signatures as stored in the signature blocks of the first system of FIGS. 1 and 2,

FIG. 10 shows an alternate state payload design where the state payload is generated and populated by the virus signature comparison circuit of the first system of FIGS. 1 and 2.

FIG. 11 is an alternate method of the present invention wherein the first system of FIG. 2 is configured and applied to detect a pattern contained within a data file.

### DETAILED DESCRIPTION OF A PREFERRED EMBODIMENT

In describing the preferred embodiments, certain terminology will be defined. Such terminology is intended to encompass the recited embodiment, as well as all technical equivalents, which operate in a similar manner for a similar purpose to achieve a similar result.

The terms “computer” and “workstation” as used herein are defined to comprise an electronic computational or communications device that may communicate, or be configured to communicate, data or signals via a computer-readable medium, the Internet and/or other suitable computer networks known in the art, or may be communicatively linked with at least one computer-readable medium.

The term “computer-readable medium” as used herein refers to any suitable medium known in the art that participates in providing instructions to the network for execution. Such a medium may take many forms, including but not limited to, non-volatile media, volatile media, and transmission media. Non-volatile media includes, for example, optical or magnetic disks, tapes and thumb drives. Volatile media includes dynamic memory. Transmission media includes coaxial cables, copper wire and fiber optics. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to the network for execution. For example, the instructions may initially be carried on a magnetic disk of a remote computer. The remote computer can load the instructions into its dynamic memory and send the instructions over a telephone line using a modem. A modem local to or communicatively linked with the network can receive the data on the telephone line and use an infra-red transmitter to convert the data to an infra-red signal. An infra-red detector can receive the data carried in the infra-red signal and appropriate circuitry can provide the data to the network.

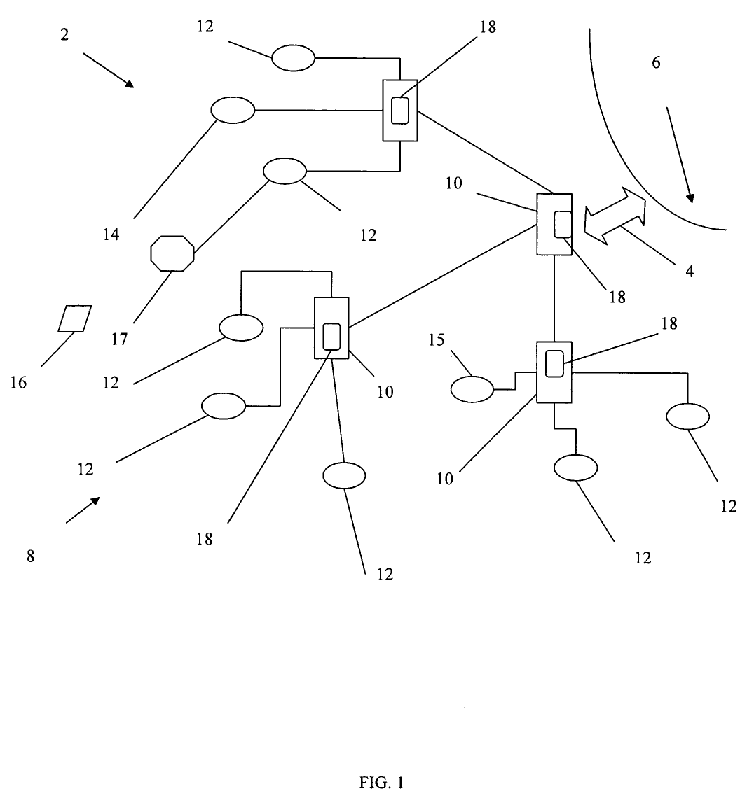

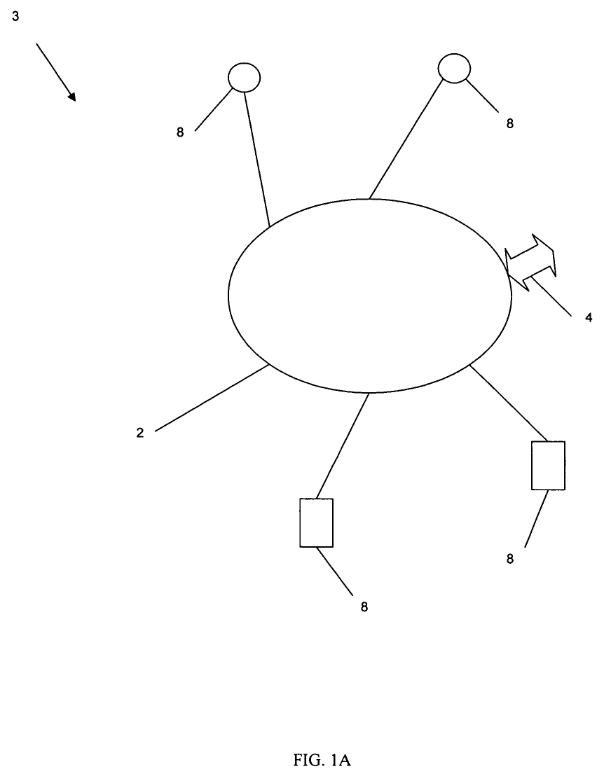

Referring now generally to the Figures and particularly to FIG. 1, FIG. 1 illustrates a network 2 of an information technology system 3 communicatively coupled by a communications link 4 with the Internet 6. A physical layer of an OSI networking framework of the network 2 is employed by the communications link 4. The network 2 includes elements 8, such as network computers 10, computers 12, data storage devices 14, communications systems 15, computer-readable media 16 and a media reader 17. The media reader 17 and the computer-readable media 16 are configured to enable the media reader 17 to read software code from the computer-readable media 16 and transmit the read software code to one or more elements 8 of the network 2. The media reader is communicatively coupled with at least one computer 12. A first preferred embodiment of the present invention 18, or first system 18, is comprised within the network computer 10.

Referring now generally to the Figures and particularly FIG. 1A, the information technology system 3 includes the network 2 and optionally the bi-directional communications link 4. The network 2 includes a plurality of elements 8. One or more elements 8 may be or comprise a suitable electronic device or media known in the art, to include a network computer 10, a computer 12, a data storage device 14, a communications system 15, a computer-readable media 16, a media reader 17, and/or a first system 18.

The term element is defined herein to include computers, workstations, data storage devices, wireless computational devices and other suitable computational and communications devices and systems known in the art.

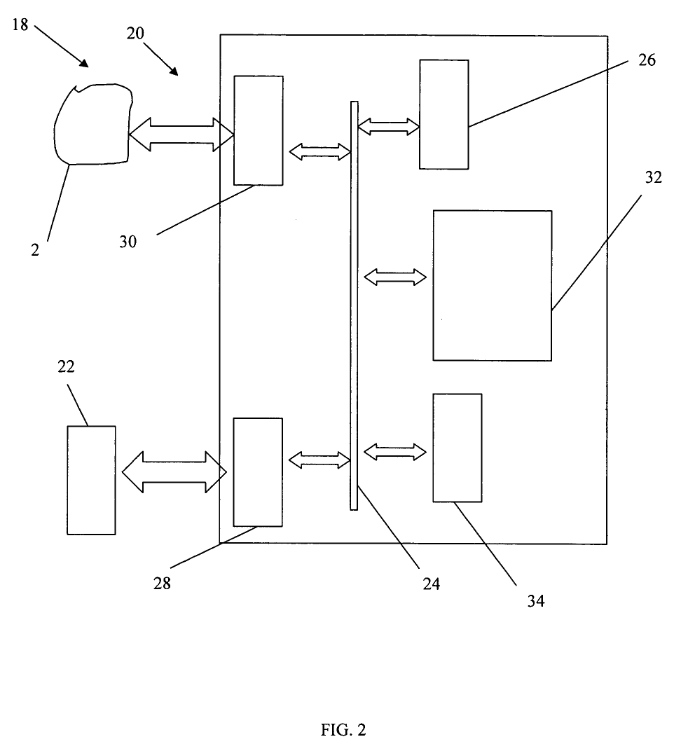

Referring now generally to the Figures and particularly to FIG. 2, FIG. 2 is a schematic diagram of the first system 18 of the network 2 of FIG. 2. The first system 18 includes a network processor 20 and a DRAM 22. The network processor 20 is an integrated circuit formed on a substrate 21 and has an on-chip communications bus 24 that communicatively couples several on-chip components of the network processor 20, to include a central processor unit (“CPU”) 26, a DRAM controller module (“DCM”) 28, an input/output module 30, a system memory 32, and an intrusion detection module 34. It is understood that the term CPU as defined herein includes CPU embodiments having one or more central processing units, wherein two or more central processing units are configured to support logic processing and computation of two or more interleaved strings and/or other elements of software program. The input/output module 30, or IOM 30, communicatively couples the communications network 2 with the network processor 20 and the communications bus 24. The DCM 28 is a memory manager device and provides bi-directional communication between the DRAM 22, or DRAM channel 22, and the communications bus 24. The system memory 32 is employed by the CPU 26 in the processing of a data packet 33 and other information communicated from the network 2 to first system 18. The intrusion detection module 34 compares specified patterns of data, or signatures, with the contents of the packet 33 as provided and directed by the CPU 26.

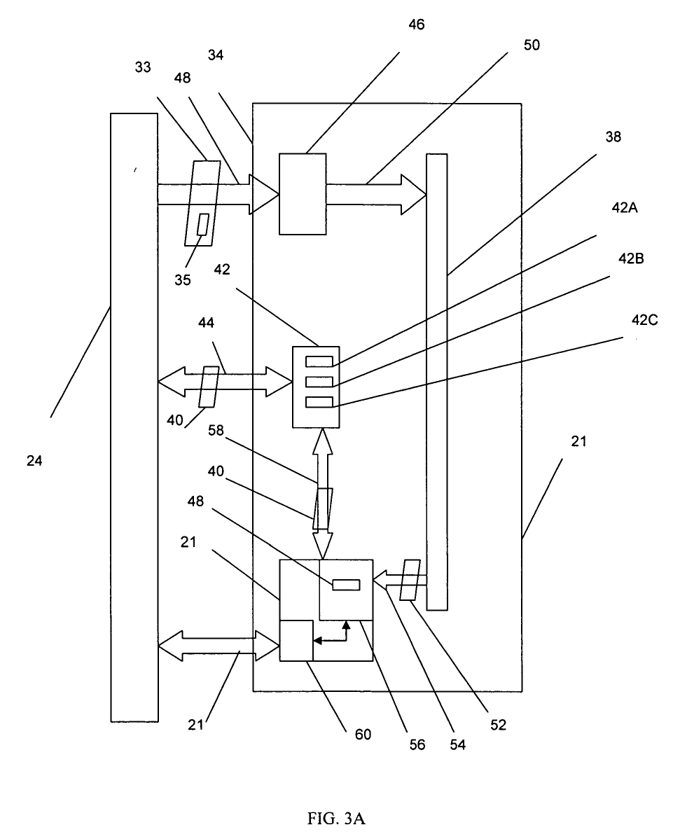

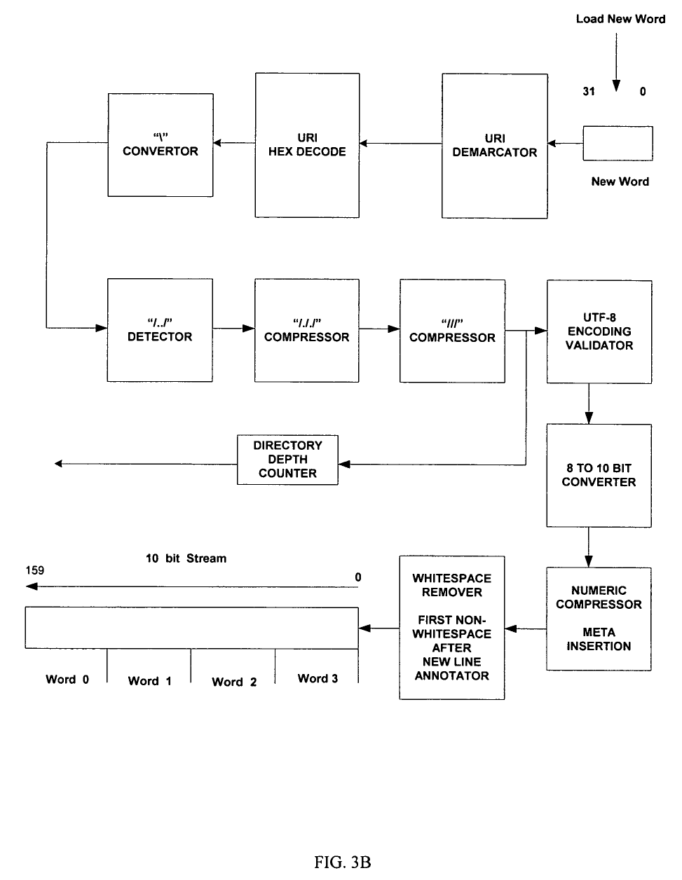

Referring now generally to the Figures and particularly to FIG. 3A, FIG. 3A is a schematic diagram of the intrusion detection module 34 of the first system 2 of FIGS. 1 and 2. The intrusion detection module (“IDM”) 34, includes a hardware packet normalization pipeline 38 that accepts packets 33 from the communications bus 24 and normalizes each received packet 33 for comparison with virus signatures 40 as stored in a plurality of signature blocks 42. It is understood that, in various alternate preferred embodiments of the method of the present invention, the IDM 34 may be configured and applied to detect a specified data pattern 35 contained with a data file, wherein the data pattern is not associated with a virus, and the data file may be an electronic message or other suitable data document known in the art. Each signature block 42 comprises one or more registers 42A 42B 42C where each register records a signature 40 or a portion of a signature 40. It is understood that the signature blocks 42 may, in certain alternate preferred embodiments of the method of the present invention, receive and store signatures 40 related to or derived from one or more URL's, portion of content of the data packet 33, and/or a traffic classification indicator of the data packet 33. The signatures 40 are communicated to the signature blocks 42 via the communications bus 24 and via the signature block data pathway 44. An input module 46 accepts the data packet 33 from the communications bus via an input data pathway 48 and communicates the data packet 33 via a data pathway 50 to the hardware packet normalization pipeline 38, or pipeline 38. All or some of the data packet 33 is then normalized by the pipeline 38 to generate a normalized data 52, and the normalized data 52 is provided to a shift register 48 of a comparison circuit 50 via a normalized data pathway 54. The comparison circuit 50 compares signatures 40 with the values of the shift register 48 as the normalized data 46 is sequenced through the shift register 48 on a bit by bit, byte by byte, or other suitable data grouping known in the art. The signatures 40 are communicated to the comparison circuit 50 from the signature blocks 42 via a signature pathway 58. The comparison circuit 50 reports the results of the comparison of the normalized data 52 with one or more signatures 40 to a logic circuit 60 via results pathway 62. The logic circuit 60 determines which results of the comparisons of the signatures 40 and the normalized data 52 by the comparison circuit 56 to the CPU 26 and via a data link 62.

Referring now generally to the Figures and particularly to FIG. 3B, FIG. 3B is a schematic diagram of the intrusion detection module 34 of the first system 2 of FIGS. 1 and 2. The packet 33 passes from the data pathway 50 and into a new word register 64 were elements of the packet 33 are sequentially stored until transmission to a URL demarcator 66. The URI demarcator 66 performs a method limit check on the packet 33 and uses a URI flag in a packet signature of the packet 33. The packet 33 is then processed through a URI hex decode circuit 68. The packet 33 is then serially processed by a backslash converter circuit 70, a “/../” converter 72, a “/././” compressor 74, and a “///” compressor 76 to at least partially normalize the packet 33. The packet 33 is then provided to a UTF-8 encoding validator 78, and depth information derived from the data packet 33 is provided to a directory depth counter 80. The packet is next processed by an 8 to 16 bit converter 82 and then by a numeric compressor and meta insertion circuit 84. A whitespace remover 86 then processes the packet 33 wherein the first non-whitespace after a new line of the packet is annotated.

In certain still alternate preferred embodiments of the present invention, the information technology system has a CPU, a shift register for processing streams of packets of binary data, a first signature register and a second signature register, wherein a method of pattern detection is executed, the method comprising:
storing a first signature in the first signature register;
storing a second signature in the second signature register;
sequencing a portion of a first data packet through the shift register;
substantively simultaneously comparing the first signature and the second signature with the contents of the shift register after each advance of the first packet of the data stream through the shift register; and
reporting when a match is determined to exist between the instantaneous values of the shift register and either the first signature or the second signature.

The first signature and/or second signature may be patterns related or derived from a virus, a universal resource locator, a traffic classification indicator, and/or a portion of content of a data packet. There may be one or more value positions of a signature that are null values (i.e. “do not care” values) or a case insensitive value.

The CPU may optionally prevent the transmission of the first data packet to an address specified by the first data packet when a match is determined to exist between the instantaneous values of the shift register and either the first signature or the second signature.

Certain other alternate preferred embodiments of the present invention include one or more of the following steps in detecting potential viruses in the data packets:
appending a portion of the first signature to the data packet;
sequencing the data packet through the shift register;
comparing a remainder of the first signature with the contents of the shift register after each advance of the data packet through the shift register; and
reporting to the CPU when a match is determined to exist between the instantaneous values of the shift register and the first signature.

Certain yet alternate preferred embodiments of the present invention include one or more of the following steps in detecting potential viruses in the data packets:
storing a first portion of the first signature in the first signature register;
storing a second portion of first signature in the second register, whereby the second signature comprises the second portion of the first signature; and
comparing the first portion of the first register and second portion of the second register concurrently with the instantaneous values of the shift register.

The information technology system may further include a third signature register, where the third signature register records the value of a third signature, whereby the information technology system may substantively simultaneously compare the first signature and the third signature with the contents of the shift register after each advance of the first packet of the data stream through the shift register. The CPU may additionally be informed when a match is determined to exist between the instantaneous values of the shift register and either the first signature or the third signature.

The information technology system may, in certain yet alternate preferred embodiments of the present invention, include:
a data stream source and an integrated circuit, the data stream source coupled with the integrated circuit, and the data stream source providing a plurality of packets of binary data; and
the integrated circuit including a substrate, a central processing unit (“CPU”), a shift register for receiving and sequencing through the plurality of packets of binary data, a first signature register and a second signature register, wherein the CPU, the shift register, the first signature register and the second signature register are communicatively coupled and are located within the substrate.

Certain other alternate preferred embodiments of the present invention include an integrated circuit comprising a normalization pipeline, the normalization pipeline located within the substrate and communicatively coupled with the data source a shift register, and the normalization pipeline for accepting the data stream from the data source, deriving a normalized binary pattern from a first packet of the data stream, and for providing the normalized binary pattern to the shift register, whereby the comparisons with a first virus signature and the second virus signature are made with a normalized binary pattern. The integrated circuit may further comprise a plurality of signature registers located within the substrate and communicatively coupled with the shift register, and the plurality of signature registers for each accepting a portion of a plurality of portions of the first signature, wherein the plurality of portions of the first signature are sequentially stored in the plurality of signature registers, and the plurality of portions of the first signature is sequentially compared against the instantaneous values of the shift register, whereby a data packet of length equal to or less than the first signature is concurrently compared for a match with a first packet of the plurality of data packets. In still other preferred embodiments of the method of the present invention, a plurality of portions of the first signature are sequentially compared against the instantaneous values of the first packet and a second packet as sequenced through the shift register, whereby two data packets of summed length equal to or less than the first signature are substantially simultaneously compared for a match with a first signature

Certain other alternate preferred embodiments of the present invention provide a computer-readable memory medium on which are stored a plurality of computer-executable instructions for performing aspects of the present invention as recited herein.

The information technology system, having a central processing unit (“CPU”), a shift register for processing binary data, and a first signature register and a second signature register, may execute a method of virus intrusion detection comprising:
storing a first virus signature in the first signature register;
storing a second virus signature in the second signature register;
sequencing a binary data stream through the shift register;
substantively simultaneously comparing the first virus signature and the second virus signature contents of each shift register after each advance of the data stream through the shift register; and
reporting when a match is determined to exist between the instantaneous values of the shift register and either the first virus signature or the second virus register.

Certain yet other alternate preferred embodiments of the present invention comprise a programmable logic device, such as a programmable gate array, to perform one or more of the steps or aspects of the present invention as recited herein.

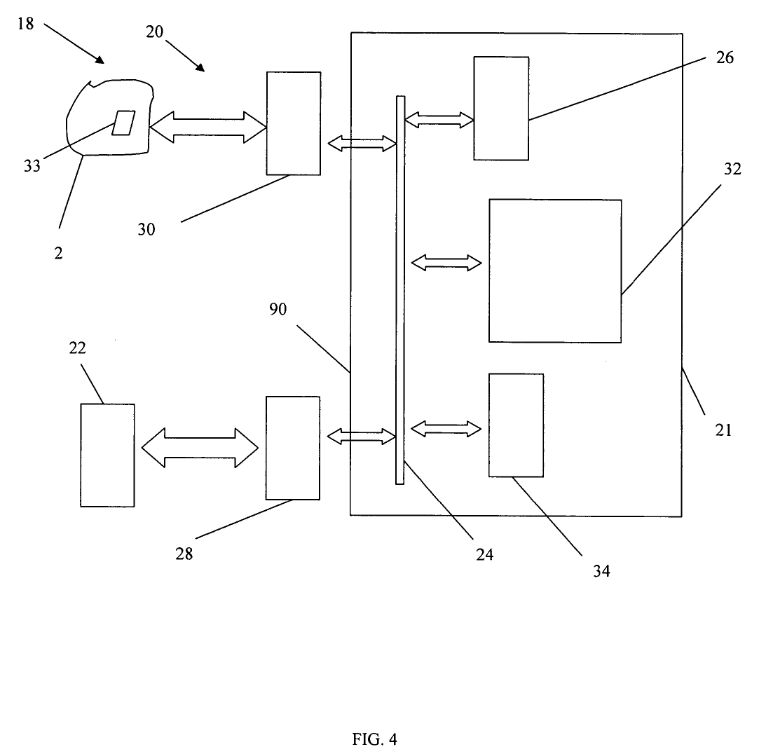

Referring now generally to the Figures and particularly to FIG. 4, FIG. 4 is a schematic diagram of an alternate preferred embodiment of the present invention 88, or second system 88, wherein a programmable gate array 90 comprises the communications bus 24 the DCM 28, the input/output module 30, the system memory 32, and the intrusion detection module 34.

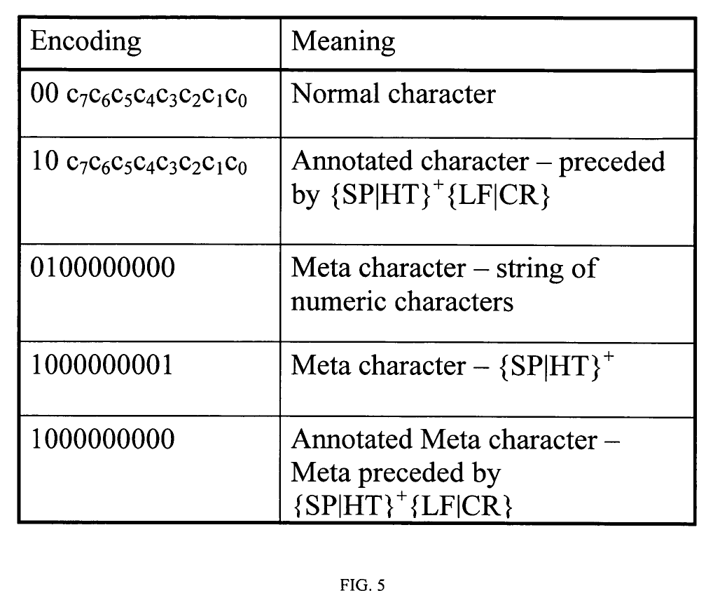

Referring now generally to the Figures and particularly to FIG. 5, the packet 33 may be processed by the packet normalization pipeline 38 in a 10 bit stream in certain alternate preferred embodiments of the method of the present invention. FIG. 5 presents the meanings of selected 10-bit character encodings.

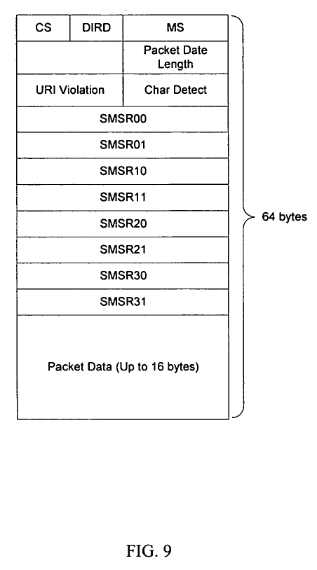

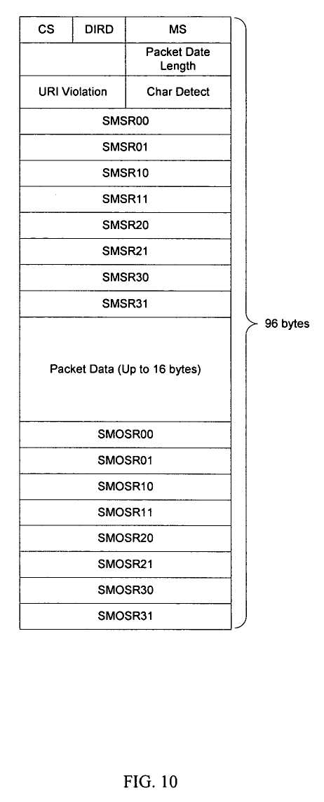

The packet 33 is accepted from the packet normalization pipeline 38 by a virus signature comparison circuit 56. The virus signature comparison circuit 56 compares data derived from or otherwise related to content of the packet 33 with the virus signatures 40 stored in the signature blocks 42. A state payload 92, as described in FIG. 9 and in an alternate layout in FIG. 10, is then generated by the virus signature comparison circuit 56, wherein the results of the virus signature comparisons are noted in the state payload 92. The state payload 92 is then transmitted via the communications bus 24 to the CPU 26. The CPU 26 then examines the state payload to determine if a virus signature match occurred. May it be noted that the invention is not limited to a 10 bit stream normalization pipeline and used here only for illustrative purposes.

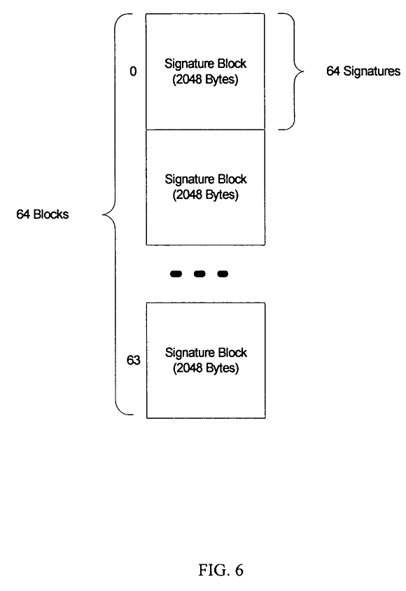

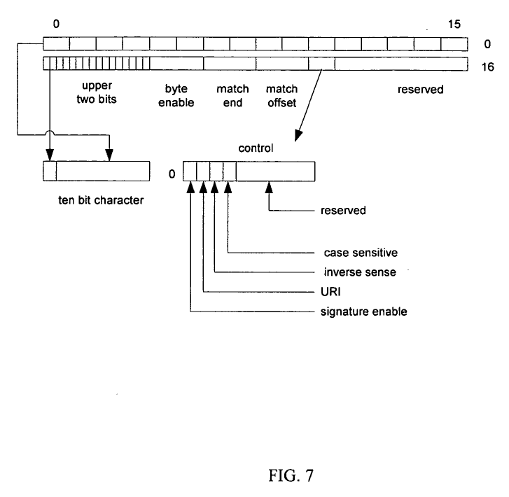

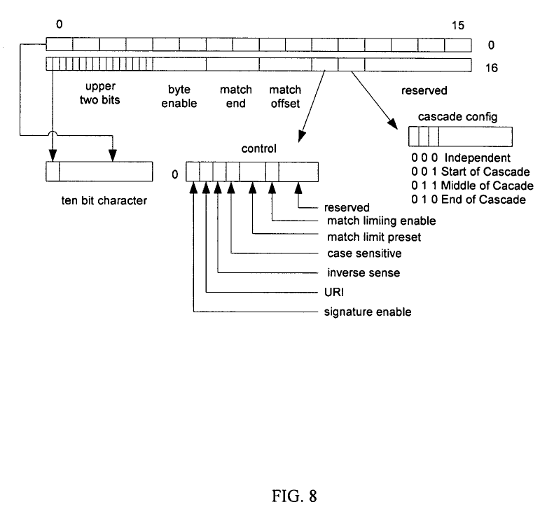

Referring now generally to the Figures and particularly to FIGS. 6, 7 and 8. FIG. 6 presents a layout 94 of signature blocks 40, each signature block 40 having a capacity for 64 signatures of 4K each. FIG. 7 presents a first syntax of each individual virus signature 42 and FIG. 8 presents alternate virus signature syntax. May it be noted that the invention is not limited to signature blocks of 64 signature capacity, used here only for illustrative purposes.

Referring now generally to the Figures and particularly to FIGS. 9 and 10, FIG. 9 presents a state payload 96 resulting from a comparison of the processed or normalized packet data with the virus signatures 42 as stored in the signature blocks 40. FIG. 10 shows an alternate state payload design 98, where the state payload 96 is generated and populated by the virus signature comparison circuit 50.

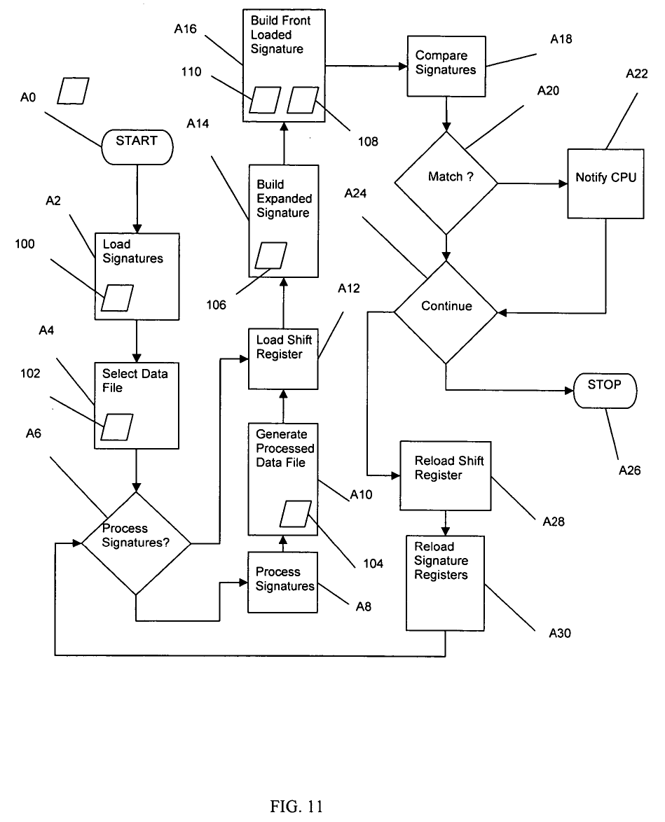

Referring now generally to the Figures and particularly to FIG. 11, a still alternate preferred embodiment of the method of the present invention provides and loads a plurality of signatures 100 into the signature blocks 40, wherein the signatures may be or contain any suitable data pattern known in the art, to include ASCII data, UNICODE data, numerical data. An individual signature 100 may be contained within, or indicate the presence of or attempted intrusion by, or be related to a spyware code, an adware code, or other suitable data pattern known in the art. In step A2 each signature 100 of the plurality signatures 100 are individually loaded into specific signature registers 42A, 42B & 42C of the signature blocks 40. In step A4 a data file 102 is selected. The data file 102 may be a component or packet of an electronic message, or of an electronic document accessible to the network computer 10. In optional step A6 certain still other alternate preferred embodiments of the present invention determine if the data file 102 should be directly loaded into the shift register 48, or alternately should be processed through an optional pipeline 38. In optional step A8 the data file 102 is processed through the pipeline 38, wherein the data of the data file 102 may be reconfigured in accordance with suitable methods known in the art to de-obfuscate, decrypt, and/or reformat the data file 102 to enable matching of the informational contents of the data file 102 with the signatures 100. In optional step A10 the pipeline generates a processed data file 104 and provides the processed data file 104 to the shift register 48

The data file 102 or the processed data file 104, or a portion of the data file 102 or processed data file 104, is loaded into the shift register 48 in Step A12. In optional step A14 the signature block 42 is configured to link two or more signatures 100 stored in the shift registers 42A, 42B & 42C whereby a plurality of signatures 100 are organized for comparison in series with the contents of the shift register 48. Optional step A14, in combination with the others steps of the method of FIG. 11, enables the network computer 10 to compare the contents of the shift register 48 with an expanded signature 106, wherein the expanded signature 106 comprises two or more signatures 100. In optional step A16 one or more signatures 100 are preloaded with a front pattern 108 to produce one or more front loaded signatures 110. The front pattern 108 may be related to a pattern, a virus or an attempted intrusion by a virus. The application of step A16 in combination with other steps of the method of the present invention of FIG. 11 enables the method of FIG. 11 to determine if a data pattern sought for detection by the IDM 34 is comprised within one or more data files 102. In step A18 the signatures 100 as stored in the signature block registers 42A, 42B & 42C, and optionally (1) one or more expanded signature 106 and/or (2) one or more front loaded signatures 110, are compared with the contents of the shift register 48. In step A20 a determination is made if any match is found to exist with the signatures 100, expanded signature 106, or front loaded signature 110, and the CPU 26 is notified in step A22 of any positive determination of a match.

The network computer 10 determines in step A24 if the steps A6 through A24 should be again executed, or if the method of FIG. 11 should pause or cease, as per step A26. In step A28 the shift register is reloaded with another portion of the data file 102, or with elements of an alternate data file 102. It optional step A30 the signature registers 42A, 42B & 42C are reloaded with new signatures 100. It is understood that the signature blocks 42 may, in certain yet other alternate preferred embodiments of the method of the present invention, contain and employ a plurality of signature registers 42A, 42B & 42C in excess of 3 signature registers 42A, 42B, & 42C.

Those skilled in the art will appreciate that various adaptations and modifications of the aforementioned described preferred embodiments can be configured without departing from the scope and spirit of the invention. Other suitable techniques and methods known in the art can be applied in numerous specific modalities by one skilled in the art and in light of the description of the present invention described herein. Therefore, it is to be understood that the invention may be practiced other than as specifically described herein. The above description is intended to be illustrative, and not restrictive. Many other embodiments will be apparent to those of skill in the art upon reviewing the above description. The scope of the invention should, therefore, be determined with reference to the knowledge of one skilled in the art and in light of the disclosures presented above.

We claim:

1. An information technology system having a central processing unit (“CPU”), a shift register for processing a plurality of packets of binary data, a first signature register and a second signature register, and a method of pattern detection comprising:
f. storing a first signature in the first signature register;
g. storing a second signature in the second signature register;
h. sequencing a portion of a first data packet through the shift register;
i. concurrently comparing the first signature register and the second signature register with the contents of the shift register after each advance of the first packet of the data stream through the shift register; and
j. reporting when a match is determined to exist between the instantaneous values of the shift register and either the first signature or the second signature.

2. The method of claim 1, wherein the first signature comprises a pattern related to a first virus.

3. The method of claim 2, wherein the second signature comprises a pattern related to a second virus.

4. The method of claim 1, wherein at least one value position of the first signature is a do-not-care value.

5. The method of claim 1, wherein at least one position value of the first signature is case insensitive.

6. The method of claim 2, wherein the method further comprises preventing the transmission of the first data packet to an address specified by the first data packet when a match is found between an instantaneous value in the shift register and either the first signature or the second signature.

7. The method of claim 1, the method further comprising:
a. appending a portion of the first signature to the data packet;
b. sequencing the data packet through the shift register;
c. comparing a remainder of the first signature with the contents of the shift register after each advance of the data packet through the shift register; and
d. reporting when a match is found between the instantaneous values of the shift register and the first signature.

8. The method of claim 1, wherein the method further comprises:
a. storing a first portion of the first signature in the first signature register;
b. storing a second portion of first signature in the second register, whereby the second signature comprises the second portion of the first signature; and
c. comparing the contents of the first register and the second register in sequence with the instantaneous values of the shift register.

9. The method of claim 8, wherein the first signature comprises a pattern related to a first virus.

10. The method of claim 1, wherein the first signature comprises a pattern related to data selected from the group of data consisting of a universal record locator, a portion content of a data packet, and a traffic classification indicator.

11. The method of claim 8, wherein the information technology system further includes a third signature register, and wherein the method further comprises:
a. storing a third signature in the third signature register;
b. substantively simultaneously comparing the first signature and the third signature with the contents of the shift register after each advance of a first packet of the data stream through the shift register; and
c. reporting to the CPU when a match is determined to exist between the instantaneous values of the shift register and either the first signature or the third signature.

12. An information technology system, the system comprising:
a. a data stream source and an integrated circuit, the data stream source coupled with the integrated circuit, and the data stream source providing a plurality of packets of binary data;
b. the integrated circuit including a substrate, a central processing unit (“CPU”), a shift register for receiving and sequencing through the plurality of packets of binary data, a first signature register and a second signature register, wherein the CPU, the steam register, the first signature register and the second signature register are communicatively coupled and are located within the substrate;
c. the first signature register for storing a first signature, and for comparing the first signature with the instantaneous values of the shift register;
d. the second signature register for storing a second signature, and for comparing the second signature with the instantaneous values of the shift register;
e. the shift register for each advancing of a first packet of the data stream through the shift register, and substantively simultaneously comparing the first signature and the second signature with the instantaneous values of the shift register; and
f. the CPU for accepting a report when a match is determined to exist between the instantaneous values of the shift register and either the first signature or the second signature.

13. The system of claim 11, wherein the first signature comprises a pattern related to a first virus.

14. The system of claim 11, wherein the integrated circuit further comprises a normalization pipeline, the normalization pipeline located within the substrate and communicatively coupled with the data source and the shift register, and the normalization pipeline for accepting the data stream from the data source, deriving a normalized binary pattern from a first packet of the data stream, and for providing the normalized binary pattern to the shift register, whereby the comparisons with the first signature and the second signature are made with a normalized binary pattern.

15. The system of claim 11, wherein the integrated circuit further comprises a plurality of signature registers located within the substrate and communicatively coupled with the shift register, and the plurality of signature registers for each accepting a portion of a plurality of portions of the first signature, wherein the plurality of portions of the first signature are sequentially stored in the plurality of signature registers, and the plurality of portions of the first signature is sequentially compared against the instantaneous values of the shift register, whereby a data packet of length equal to or less than the first signature is substantially simultaneously compared for a match with a first packet of the plurality of data packets.

16. The system of claim 14, wherein the plurality of portions of the first signature are sequentially compared against the instantaneous values of the first packet and a second packet as stored in the shift register, whereby two data packets of summed length equal to or less than the first signature is substantially simultaneously compared for a match with the first signature.

17. The system of claim 11, wherein the first signature comprises a pattern related to a first virus.

18. A computer-readable memory medium on which are stored a plurality of computer-executable instructions for performing steps (a)-(e), as recited in claim 1.

19. An information technology system having a central processing unit (“CPU”), a shift register for streaming through binary data, and a first signature register and a second signature register, and a \ virus intrusion detection method comprising:
a. storing a first virus signature in the first signature register;
b. storing a second virus signature in the second signature register;
c. sequencing a binary data stream through the shift register;
d. substantively simultaneously comparing the first virus signature and the second virus signature contents of each shift register after each advance of the data stream through the shift register; and
e. reporting to the CPU when a match is determined to exist between the instantaneous values of the shift register and either the first virus signature or the second virus register.
